(19) United States
(12) Patent Application Publication
(10) Pub. No.: US 2026/0142087 A1
(43) Pub. Date: May 21, 2026

(54) MULTILAYER ELECTRONIC COMPONENT

(71) Applicant: SAMSUNG ELECTRO-MECHANICS CO., LTD., Suwon-si (KR)

(72) Inventors: Young Jun CHA, Suwon-si (KR); Hwi Dae KIM, Suwon-si (KR); Ju Eun NAM, Suwon-si (KR); Min Kyeong SIM, Suwon-si (KR)

(73) Assignee: SAMSUNG ELECTRO-MECHANICS CO., LTD., Suwon-si (KR)

(21) Appl. No.: 19/290,925

(22) Filed: Aug. 5, 2025

(30) Foreign Application Priority Data
Nov. 15, 2024 (KR) 10-2024-0163245

(51) Int. Cl. H01G 4/30; H01G 4/012; H01G 4/232

(52) U.S. Cl. CPC H01G 4/30; H01G 4/012; H01G 4/232

(57) ABSTRACT

A multilayer electronic component includes a body including a dielectric layer and an internal electrode layer, and a plurality of external electrodes disposed on the body, wherein 0<D2/D1≤1.2 in which D1 is a gap between two external electrodes disposed adjacently in a width direction among the plurality of external electrodes and D2 is a gap between two external electrodes disposed adjacently in a length direction among the plurality of external electrodes.

### CROSS-REFERENCE TO RELATED APPLICATION(S)

This application claims benefit of priority to Korean Patent Application No. 10-2024-0163245 filed on Nov. 15, 2024 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type capacitor mounted on the printed circuit boards of various types of electronic products such as imaging devices including liquid crystal displays (LCDs) and plasma display panels (PDPs), computers, smartphones, cell phones, and the like, to allow electricity to be charged therein and discharged therefrom.

Such an MLCC may be used as a component of various electronic devices due to advantages thereof such as compactness, guaranteed high capacitance, and ease of mounting. As various electronic devices such as computers and mobile devices have been reduced in size and increased in power, demands for miniaturization and high capacitance of multilayer ceramic capacitors have increased.

Meanwhile, MLCCs have also been widely used for decoupling to remove noise from electrical signals within a set due to excellent high-frequency characteristics (low equivalent series inductance (ESL)).

In addition, in order to solve the issue of noise of high-speed integrated circuits (ICs), a type of MLCC known as a land side capacitor (LSC) may be disposed adjacently to the IC. It is known that LSCs require low thickness, high-frequency characteristics, and appropriate equivalent series resistance (low ESR).

In order to reduce ESL, it is important to minimize the number of magnetic flux linkages per unit current in a high-frequency range. To this end, various methods have been used to solve this problem, such as controlling a structure in the direction of minimizing a current loop or arranging internal electrodes and external electrodes in the direction of canceling a magnetic field. In addition, in order to maintain appropriate ESR, methods, such as arranging internal electrodes and external electrodes in the direction of minimizing the loop current, have been applied.

As mentioned above, since LSCs have been generally disposed below an IC substrate, LSCs are required to have a low thickness while having low ESL and appropriate ESR. However, multi-terminal products including three or more external electrodes has excellent capacitance, while having a small thickness, and thus, it may be difficult to manufacture products that may have low ESL characteristics or may implement appropriate ESR.

### SUMMARY

An aspect of the present disclosure is to achieve high-frequency characteristics (low ESL) of a multilayer electronic component.

Another aspect of the present disclosure is to achieve appropriate equivalent series resistance (ESR) characteristics in a multilayer electronic component.

Another aspect of the present disclosure is to reduce the thickness of a multilayer electronic component.

Another aspect of the present disclosure is to improve capacitance characteristics of a multilayer electronic component.

However, the problems to be solved by the present disclosure are not limited to the aforementioned contents and may be more easily understood in the process of describing specific embodiments of the present disclosure.

According to an aspect of the present disclosure, a multilayer electronic component includes: a body including a dielectric layer and internal electrode layers alternately disposed with the dielectric layer in a first direction, the body including first and second surfaces opposing each other in the first direction, third and fourth surfaces opposing each other in a second direction and connected to the first and second surfaces, and fifth and sixth surfaces opposing each other in a third direction and connected to the first to fourth surfaces; and an external electrode including a first electrode layer disposed on the body, and a second electrode layer disposed on the first electrode layer and connected to the internal electrode layers, wherein the external electrode includes first to third external electrodes disposed on portions of the first, second, and fifth surfaces, respectively, and fourth to sixth external electrodes disposed on portions of the first, second, and sixth surfaces, respectively, and 0<D2/D1≤1.2 in which D1 is a width of a gap between two adjacent external electrodes, among the first to sixth external electrodes, in the third direction and D2 is a width of a gap between two adjacent external electrodes, among the first to sixth external electrodes, in the second direction.

According to another aspect of the present disclosure, a multilayer electronic component including a body including a dielectric layer and internal electrode layers alternately disposed with the dielectric layer in a first direction, the body including first and second surfaces opposing each other in the first direction, third and fourth surfaces opposing each other in a second direction and connected to the first and second surfaces, and fifth and sixth surfaces opposing each other in a third direction and connected to the first to fourth surfaces; and a plurality of external electrodes including a first electrode layer disposed on the body, and a second electrode layer disposed on the first electrode layer and connected to the internal electrode layers, wherein 0<D2/D1≤1.2 in which D1 is a width of a gap between two adjacent external electrodes, among the plurality of external electrodes, in the third direction and D2 is a width of a gap between two adjacent external electrodes, among the plurality of external electrodes, disposed in the second direction.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an embodiment of the present disclosure;

FIGS. 2A and 2B are cross-sectional views including an internal electrode layer in an embodiment of the present disclosure;

FIGS. 3A and 3B are cross-sectional views including an internal electrode layer in another embodiment of the present disclosure;

FIG. 4 is a cross-sectional view taken along line I-I′ of FIG. 1; and

FIG. 5 schematically illustrates Lm according to the results of evaluating moisture resistance reliability of Comparative Example and Example.

### DETAILED DESCRIPTION

Hereinafter, exemplary embodiments of the present inventive concept will be described in detail with reference to the accompanying drawings. The inventive concept may, however, be exemplified in many different forms and should not be construed as being limited to the specific embodiments set forth herein. Rather, these embodiments are provided so that this disclosure will be thorough and complete, and will fully convey the scope of the inventive concept to those skilled in the art. In the drawings, the shapes and lengths of elements may be exaggerated for clarity, and the same reference numerals will be used throughout to designate the same or like elements.

To clarify the present disclosure, portions irrespective of description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising,” will be understood to imply the inclusion of stated elements but not the exclusion of any other elements.

In the drawings, the Z-direction may be defined as a stacking direction or a thickness direction T, the X-direction as a length direction L, and the Y-direction as a width direction W.

### Multilayer Electronic Component

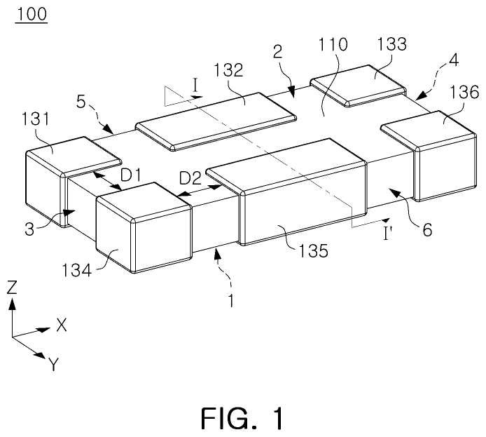

FIG. 1 is a perspective view schematically illustrating a multilayer electronic component according to an embodiment of the present disclosure;

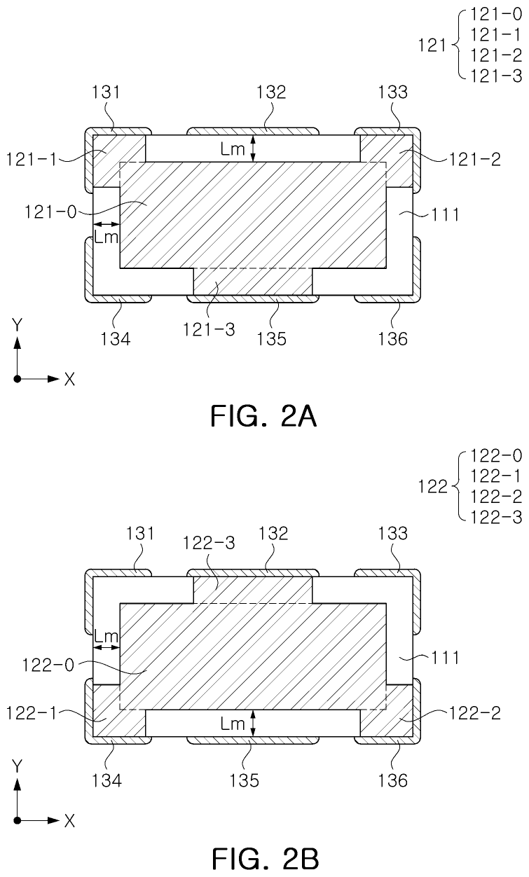

FIGS. 2A and 2B are cross-sectional views including an internal electrode layer in an embodiment of the present disclosure;

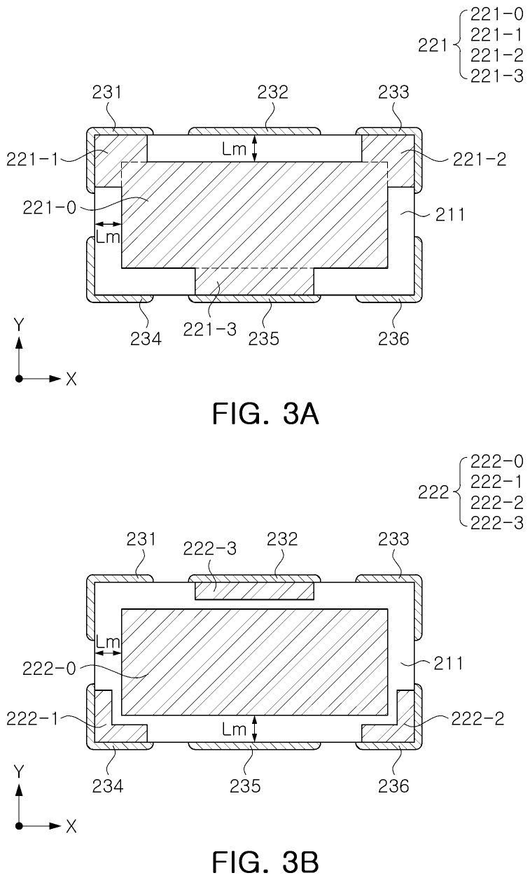

FIGS. 3A and 3B are cross-sectional views including an internal electrode layer in another embodiment of the present disclosure;

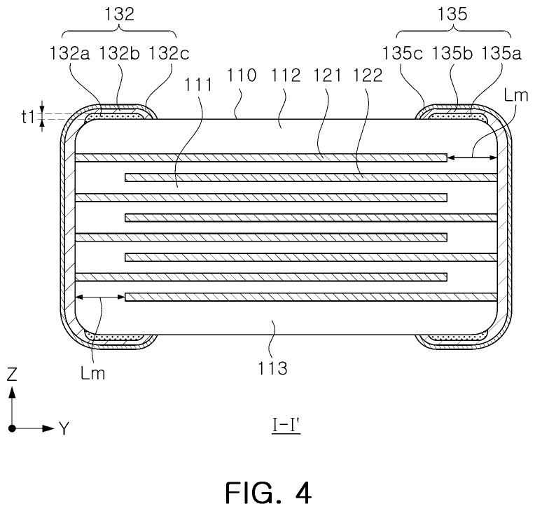

FIG. 4 is a cross-sectional view taken along line I-I′ of FIG. 1; and

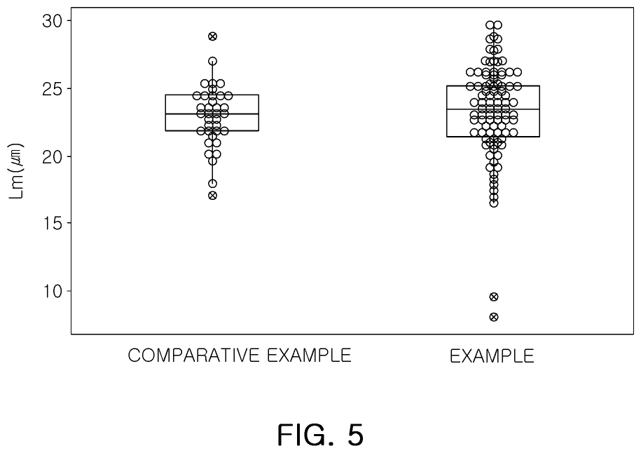

FIG. 5 schematically illustrates Lm according to the results of evaluating moisture resistance reliability of Comparative Example and Example.

Hereinafter, a multilayer electronic component according to an embodiment of the present disclosure will be described in detail with reference to FIGS. 1 to 5. However, a multilayer ceramic capacitor is described as an example of a multilayer electronic component, but the present disclosure may also be applied to various electronic products using a dielectric composition, such as inductors, piezoelectric elements, varistors, or thermistors.

A multilayer electronic component 100 according to an embodiment of the present disclosure includes a body 110 including a dielectric layer 111 and internal electrode layers 121 and 122 alternately disposed with the dielectric layer 111 in the first direction and including first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first to fourth surfaces 1, 2, 3, and 4 and opposing each other in the third direction; and external electrodes 131, 132, 133, 134, 135, and 136 including first electrode layers 131a, 132a, 133a, 134a, 135a, and 136a disposed on the body 110 and second electrode layers 131b, 132b, 133b, 134b, 135b, and 136b disposed on the first electrode layers 131a, 132a, 133a, 134a, 135a, and 136a and connected to the internal electrode layers 121 and 122, wherein the external electrodes 131, 132, 133, 134, 135, and 136 include first to third external electrodes 131, 132, and 133 respectively disposed on portions of the first, second and fifth surfaces 1, 2, and 5 and fourth to sixth external electrodes 134, 135, and 136 respectively disposed on portions of the first, second and sixth surfaces 1, 2, and 6, and 0<D2/D1≤1.2 in which D1 is a width of a gap between two external electrodes adjacently disposed in the third direction among the first to sixth external electrodes 131, 132, 133, 134, 135, and 136 and D2 is a width of a gap between two external electrodes adjacently disposed in the second direction among the first to sixth external electrodes 131, 132, 133, 134, 135, and 136.

In the body 110, the dielectric layers 111 and the internal electrode layers 121 and 122 may be alternately stacked.

More specifically, the body 110 may include a capacitance formation portion forming capacitance, including the first internal electrode layer 121 and the second internal electrode layer 122 disposed inside the body 110 and alternately disposed to face each other with the dielectric layer 111 interposed therebetween.

Although a specific shape of the body 110 is not particularly limited, as shown, the body 110 may have a hexahedral shape or a shape similar thereto. Due to the shrinkage of ceramic powder particles included in the body 110 during a sintering process, the body 110 may not have a perfectly straight hexahedral shape but may have a substantially hexahedral shape.

The body 110 may have first and second surfaces 1 and 2 opposing each other in the first direction, third and fourth surfaces connected to the first and second surfaces 1 and 2 and opposing each other in the second direction, and fifth and sixth surfaces connected to the first to fourth surfaces 1, 2, 3, and 4 and opposing each other in the third direction.

The plurality of dielectric layers 111 forming the body 110 are in a sintered state, and adjacent dielectric layers 111 may be integrated such that boundaries therebetween may not be readily apparent without using a scanning electron microscope (SEM).

A material for forming the dielectric layer 111 is not limited as long as sufficient electrostatic capacitance may be obtained. In general, perovskite (ABO₃)-based materials may be used, and for example, a barium titanate-based material, a lead composite perovskite-based material, or a strontium titanate-based material may be used. The barium titanate-based material may include a BaTiO₃-based ceramic powder particles, and the ceramic powder particles may include BaTiO₃ and (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1) or Ba(Ti_{1-y}Zr_{y}) O₃ (0<y<1) in which Ca, Zr, and the like are partially dissolved in BaTiO₃.

In addition, as a material for forming the dielectric layer 111, various ceramic additives, organic solvents, binders, dispersants, etc. may be added to powder particles, such as barium titanate (BaTiO₃), according to purposes of the present disclosure.

Meanwhile, to be distinguished from the dielectric layer included in the cover portions 112 and 113 described below, the dielectric layer 111 included in the capacitance formation portion may be defined as a first dielectric layer, and the dielectric layer included in the cover portions 112 and 113 may be defined as a second dielectric layer, and the first dielectric layer and the second dielectric layer may be the same or different and are not particularly limited.

In addition, since the first and second dielectric layers may be formed using a dielectric material, such as barium titanate (BaTiO₃), the first and second dielectric layers may include a dielectric microstructure after firing. The dielectric microstructure may include a plurality of dielectric crystal grains, a crystal grain boundary disposed between the adjacent dielectric crystal grains, and n-points disposed at points at which three or more of the grain boundaries contact each other and may include a plurality of dielectric crystal grains, a plurality of grain boundaries, and a plurality of n points.

A first-direction length of the dielectric layer 111 may not need to be particularly limited.

However, in order to more easily achieve miniaturization and high capacitance of the multilayer electronic component, the first-direction length of the dielectric layer 111 may be 3.0 μm or less, 2.0 μm or less, 1.0 μm or less, 0.8 μm or less, 0.6 μm or less, 0.5 μm or less, or 0.4 μm or less.

Here, the first-direction length of the dielectric layer 111 may refer to the first-direction length of the dielectric layer 111 disposed between the first and second internal electrode layers 121 and 122.

Meanwhile, the first-direction length of the dielectric layer 111 may refer to the length, distance, size, or length of the dielectric layer 111 in the first direction or may refer to a thickness of the dielectric layer 111.

Here, the first-direction length of the dielectric layer 111 may be a concept including the first-direction length of at least one of the plurality of dielectric layers 111 or may be a concept including the first-direction length of each of all the dielectric layers 111.

In addition, the first-direction length of the dielectric layer 111 may refer to a first-direction average length of one dielectric layer, may refer to a first-direction average length of each of the plurality of dielectric layers 111, or may refer to a first-direction average length of the plurality of dielectric layers 111.

The first-direction average length of the dielectric layer 111 may be measured by scanning an image of the first- and third-direction cross-sections of the body 110 with a scanning electron microscope (SEM) at 10,000× magnification. More specifically, the first-direction average length of one dielectric layer may refer to an average value calculated by measuring first-direction lengths at five points of one dielectric layer at equal gaps in the third direction in the scanned image. The five equally spaced points may be designated in the capacitance formation portion. In addition, if the average value measurement is extended to three dielectric layers to measure an average value, the first-direction average length of a plurality of dielectric layers may be further generalized.

The internal electrode layers 121 and 122 may be alternately stacked with the dielectric layer 111.

The internal electrode layers 121 and 122 may include a first internal electrode layer 121 and a second internal electrode layer 122, and the first and second internal electrode layers 121 and 122 may be alternately disposed to face each other with the dielectric layer 111 constituting the body 110 interposed therebetween. The first and second internal electrode layers 121 and 122 may be electrically separated from each other by the dielectric layer 111 interposed therebetween in the first direction.

The body 110 may be formed by alternately stacking a first ceramic green sheet on which a first internal electrode layer pattern is printed and a second ceramic green sheet on which a second internal electrode layer pattern is printed and then firing the same. Here, the first and second internal electrode layer patterns may be formed by applying an internal electrode layer paste, and after firing, the first and second internal electrode layer patterns may become the first and second internal electrode layers 121 and 122.

Hereinafter, a multilayer electronic component 100 according to an embodiment of the present disclosure is described. However, unless there is a particularly contradictory or different description, the description of the multilayer electronic component 100 according to an embodiment may also be applied to a multilayer electronic component (200, not illustrated) according to another embodiment, and a person skilled in the art will be able to appropriately understand it by referring to the differentiated reference numerals.

The internal electrode layer may include a main portion forming capacitance and a lead portion or floating portion connected to an external electrode.

Referring to FIG. 2, the multilayer electronic component according to an embodiment of the present disclosure will be described in more detail. The first internal electrode layer 121 may include a first main portion 121-0 spaced apart from at least one of the third to sixth surfaces 3, 4, 5, and 6 of the body by Lm and forming capacitance and first lead portions 121-1, 121-2, and 121-3 connected to the first main portion 121-0 and not forming capacitance. The first lead portions 121-1, 121-2, and 121-3 may be spaced apart from each other and include a 1-1 lead portion 121-1 connected to the first external electrode 131, a 1-2 lead portion 121-2 connected to the third external electrode 133, and a 1-3 lead portion 121-3 connected to the fifth external electrode 135. Here, the 1-1 lead portion 121-1 may be in contact with a portion of at least one of the third and fifth surfaces 3 and 5, and preferably may be in contact with a portion of the third and fifth surfaces 3 and 5. The 1-2 lead portion 121-2 may be in contact with a portion of at least one of the fourth and fifth surfaces 4 and 5, and preferably may be in contact with a portion of the fourth and fifth surfaces 4 and 5. Also, the 1-3 lead portion 121-3 may be in contact with a portion of the sixth surface 6.

The second internal electrode layer 122 may include a second main portion 122-0 spaced apart from at least one of the third to sixth surfaces 3, 4, 5, and 6 of the body by Lm and forming capacitance and second lead portions 122-1, 122-2, and 122-3 connected to the second main portion 122-0 and not forming capacitance. The second lead portions 122-1, 122-2, and 122-3 may be spaced apart from each other and include a 2-1 lead portion 122-1 connected to the fourth external electrode 134, a 2-2 lead portion 122-2 connected to the sixth external electrode 136, and a 2-3 lead portion 122-3 connected to the second external electrode 132. Here, the 2-1 lead portion 122-1 may be in contact with a portion of at least one of the third and sixth surfaces 3 and 6, and preferably may be in contact with a portion of the third and sixth surfaces 3 and 6. The 2-2 lead portion 121-2 may be in contact with a portion of at least one of the fourth and sixth surfaces 4 and 6, and preferably may be in contact with a portion of the fourth and sixth surfaces 4 and 6. Also, the 2-3 lead portion 122-3 may be in contact with a portion of the fifth surface 5.

Here, the second-direction length of the 2-3 lead portion 122-3 in contact with the fifth surface 5 may satisfy 1.25 times or more and 2.75 times or less of the second-direction length of each of the 1-1 lead portion 121-1 and the 1-2 lead portion 121-2 in contact with the fifth surface 5, and the second-direction length of the 1-3 lead portion 121-3 in contact with the sixth surface 6 may satisfy 1.25 times or more and 2.75 times or less of the second-direction length of each of the 2-1 lead portion 122-1 and the 2-2 lead portion 122-2 in contact with the sixth surface 6.

The second-direction length of the 2-3 lead portion 122-3 in contact with the fifth surface 5 may satisfy 1.25 times or more and 2.75 times or less of the second-direction length of the 1-1 lead portion 121-1 and the 1-2 lead portion 121-2 in contact with the fifth surface 5, and the second-direction length of the 1-3 lead portion 121-3 in contact with the sixth surface may satisfy 1.25 times or more and 2.75 times or less of the second-direction length of each of the 2-1 lead portion 122-1 and the 2-2 lead portion 122-2 in contact with the sixth surface 6, thereby realizing high-frequency characteristics (low ESL) and realizing appropriate ESR. The lengths in the second direction may be obtained using an optical microscope or an electron microscope. Other methods and/or tools appreciated by one of ordinary skill in the art, even if not described in the present disclosure, may also be used.

Referring to FIG. 3, a multilayer electronic component according to another embodiment of the present disclosure will be described. The first internal electrode layer 221 may include a first main portion 221-0 spaced apart from at least one of the third to sixth surfaces 3, 4, 5, and 6 of the body by Lm and forming capacitance and first lead portions 221-1, 221-2, and 221-3 connected to the first main portion 221-0 and not forming capacitance. The first lead portions 221-1, 221-2, and 221-3 may be spaced apart from each other and include a 1-1 lead portion 221-1 connected to the first external electrode 231, a 1-2 lead portion 221-2 connected to the third external electrode 233, and a 1-3 lead portion 221-3 connected to the fifth external electrode 235. Here, the 1-1 lead portion 221-1 may be in contact with a portion of at least one of the third and fifth surfaces 3 and 5, and preferably may be in contact with a portion of the third and fifth surfaces 3 and 5. The 1-2 lead portion 221-2 may be in contact with a portion of at least one of the fourth and fifth surfaces 4 and 5, and preferably may be in contact with a portion of the fourth and fifth surfaces 4 and 5. Also, the 1-3 lead portion 221-3 may be in contact with a portion of the sixth surface 6.

The second internal electrode layer 222 may include a second main portion 222-0 spaced apart from at least one of the third to sixth surfaces 3, 4, 5, and 6 of the body by Lm and forming capacitance and second floating portions 222-1, 222-2, and 222-3 spaced apart from the second main portion 221-0 and not forming capacitance. The second floating portions 222-1, 222-2, and 222-3 may be spaced apart from each other and include a 2-1 floating portion 222-1 connected to the fourth external electrode 234, a 2-2 floating portion 222-2 connected to the sixth external electrode 236, and a 2-3 lead portion 222-3 connected to the second external electrode 232. Here, the 2-1 floating portion 222-1 may be in contact with a portion of at least one of the third and sixth surfaces 3 and 6, and preferably may be in contact with a portion of the third and sixth surfaces 3 and 6. The 2-2 floating portion 222-2 may be in contact with a portion of at least one of the fourth and sixth surfaces 4 and 6, and preferably may be in contact with a portion of the fourth and sixth surfaces 4 and 6. Also, the 2-3 floating portion 222-3 may be in contact with a portion of the fifth surface 5.

Here, the second-direction length of the 2-3 floating portion 222-3 in contact with the fifth surface 5 may satisfy 1.25 times or more and 2.75 times or less of the second-direction length of each of the 1-1 lead portion 221-1 and the 1-2 lead portion 221-2 in contact with the fifth surface 5, and the second-direction length of the 1-3 lead portion 221-3 in contact with the sixth surface 6 may satisfy 1.25 times or more and 2.75 times or less of the second-direction length of each of the 2-1 floating portion 222-1 and the 2-2 floating portion 222-2 in contact with the sixth surface 6.

Since the second-direction length of the 2-3 floating portion 222-3 in contact with the fifth surface 5 satisfies 1.25 times or more and 2.75 times or less of the second-direction length of each of the 1-1 lead portion 221-1 and the 1-2 lead portion 221-2 in contact with the fifth surface 5 and the second-direction length of the 1-3 lead portion 221-3 in contact with the sixth surface 6 satisfies 1.25 times or more and 2.75 times or less of the second-direction length of each of the 2-1 floating portion 222-1 and the 2-2 floating portion 222-2 in contact with the sixth surface 6, high frequency characteristics (low ESL) and appropriate ESR may be realized.

In the present disclosure, Lm may satisfy 3 μm or more or 30 μm or less, preferably Lm may satisfy 3 μm or more, and more preferably Lm may satisfy 3 μm or more and 30 μm or less. That is, 3 μm≤Lm may be satisfied, and preferably 3 μm≤Lm≤30 μm may be satisfied. Here, Lm may refer to a region in which a lead portion or a floating portion is not disposed. Lm may be obtained using an optical microscope or an electron microscope. Other methods and/or tools appreciated by one of ordinary skill in the art, even if not described in the present disclosure, may also be used.

If Lm is less than 3 μm (Lm<3 μm), there may be a concern that a short circuit of the internal electrode may be induced due to external moisture penetration, thereby weakening moisture resistance reliability. If Lm exceeds 30 μm (30 μm<Lm), it may be advantageous for external moisture penetration, so the moisture resistance reliability may be excellent, but there may be a concern that a target dielectric capacitance may not be satisfied because the area in which the main portion forming capacitance is disposed is insufficient. However, in order to implement various dielectric capacitance, Lm may be more than 30 μm (30 μm<Lm).

In a case other than an embodiment of the present disclosure, even when Lm is 3 μm or more (3 μm≤Lm), the moisture resistance reliability due to external moisture penetration may not be excellent. However, in an embodiment of the present disclosure, for example, when a distance between external electrodes disposed adjacently in the third direction among a plurality of external electrodes is D1 and a distance between two external electrodes disposed adjacently in the second direction is D2, in a case in which 0<D2/D1≤1.2 is satisfied, the moisture resistance reliability due to external moisture penetration may be excellent if Lm is 3 μm or more (3 μm≤Lm). That is, for improving the reliability of the moisture resistance, Lm may be sufficient if it is 3 μm or more (3 μm≤Lm).

Meanwhile, the body 110 may be formed by alternately stacking a first ceramic green sheet printed with a first internal electrode paste, which will become the first internal electrode layer 121, and a second ceramic green sheet printed with a second internal electrode paste, which will become the second internal electrode layer 122, and then firing the same. As a printing method of the conductive paste for the internal electrode, a screen printing method or a gravure printing method may be used, but the present disclosure is not limited thereto.

A material forming the internal electrode layers 121 and 122 is not particularly limited and may include a conductive metal with excellent electrical conductivity. For example, the internal electrode layers 121 and 122 may include one or more of nickel (Ni), copper (Cu), palladium (Pd), silver (Ag), gold (Au), platinum (Pt), tin (Sn), tungsten W, titanium (Ti), and alloys thereof.

Meanwhile, the first-direction length of the internal electrode layers 121 and 122 may not be particularly limited.

However, in order to more easily achieve miniaturization and high capacitance of the multilayer electronic component, the first-direction length of the internal electrode layers 121 and 122 may be 2.0 μm or less, 1.0 μm or less, 0.8 μm or less, 0.6 μm or less, 0.5 μm or less, or 0.4 μm or less.

Here, the first-direction length of the internal electrode layers 121 and 122 may refer to a length, distance, size, or length of the internal electrode layers 121 and 122 in the first direction or may refer to a thickness of the internal electrode layers 121 and 122.

Here, the first-direction length of the internal electrode layers 121 and 122 may be a concept including the first-direction length of at least one of the plurality of internal electrode layers 121 and 122 or may be a concept including the first-direction length of each of both the internal electrode layers 121 and 122.

In addition, the first-direction length of the internal electrode layers 121 and 122 may refer to the first-direction average length of one internal electrode layer, may refer to the first-direction average length of each of the plurality of internal electrode layers 121 and 122, or may refer to the first-direction average length of the plurality of internal electrode layers 121 and 122.

The first-direction average length of the internal electrode layers 121 and 122 may be measured by scanning an image of the first- and third-direction cross-sections of the body 110 with a scanning electron microscope (SEM) at 10,000× magnification. More specifically, the first-direction average length of one internal electrode layer may be an average value calculated by measuring first-direction lengths at five points of one internal electrode layer at equal gaps in the third direction in the scanned image. The five equally spaced points may be designated in the capacitance formation portion. In addition, if the average value measurement is extended to three internal electrode layers to measure an average value, the first-direction average length of a plurality of dielectric layers may be further generalized.

Meanwhile, the body 110 may include cover portions 112 and 113 disposed on both first-direction end surfaces the capacitance formation portion.

Specifically, the body 110 may include a first cover portion 112 disposed on one surface of the capacitance formation portion in the first direction and a second cover portion 113 disposed on the other surface of the capacitance formation portion in the first direction. More specifically, for example, the body 110 may include an upper cover portion 112 disposed on an upper surface of the capacitance formation portion in the first direction and a lower cover portion 113 disposed on a lower surface of the capacitance formation portion in the first direction.

The first cover portion 112 and the second cover portion 113 may be formed by arranging or stacking a single second dielectric layer or two or more second dielectric layers on the upper and lower surfaces of the capacitance formation portion in the first direction, respectively, and may basically play a role of preventing damage to the internal electrode layers 121 and 122 due to physical or chemical stress.

The first cover portion 112 and the second cover portion 113 may not include the internal electrode layers 121 and 122 and may include the same dielectric material as the first dielectric layer 111 of the capacitance formation portion. That is, the first cover portion 112 and the second cover portion 113 may include a ceramic material, for example, a barium titanate (BaTiO₃)-based ceramic material.

Meanwhile, the first-direction length of the cover portions 112 and 113 may not be particularly limited, and the description of the first-direction length of the cover portions 112 and 113 below may refer to the first-direction length of each of the first cover portion 112 and the second cover portion 113.

However, in order to more easily achieve miniaturization and high capacitance of the multilayer electronic component, the first-direction length of the cover portions 112 and 113 may be 100 μm or less, 50 μm or less, 30 μm or less, or 20 μm or less.

Here, the first-direction length of the cover portions 112 and 113 may refer to the length, distance, size, or length of the cover portions 112 and 113 in the first direction or may refer to the thickness of the cover portions 112 and 113.

In addition, the first-direction length of the cover portions 112 and 113 may refer to the first-direction average length of each of the first and second cover portions 112 and 113 or may refer to the first-direction average length of the first and second cover portions 112 and 113.

The first-direction average length of the cover portions 112 and 113 may be measured by scanning an image of the first- and third-direction cross-sections of the body 110 with a scanning electron microscope (SEM) at 10,000× magnification. More specifically, the first-direction average length of the cover portions 112 and 113 may refer to an average value calculated by measuring first-direction sizes at five points of one cover portion at equal gaps in the third direction in the scanned image.

In an embodiment of the present disclosure, the structure in which the multilayer electronic component 100 has six external electrodes 131, 132, 133, 134, 135, and 136 is described, but the number or shape of the external electrodes may be changed depending on the shape of the internal electrode layers 121 and 122 or other purposes.

The external electrodes 131, 132, 133, 134, 135, and 136 may be disposed on the body 110 and connected to the internal electrode layers 121 and 122.

Here, the external electrode may be disposed to cover the lead portion or floating portion exposed so that the internal electrode layer is exposed to be in contact with at least one surface of the body. Here, the fact that the external electrode is disposed to cover the lead portion or floating portion of the internal electrode layer may mean that the lead portion or floating portion of the internal electrode layer is not exposed externally and is not visible when the multilayer electronic component is observed or measured from the outside.

The external electrodes 131, 132, 133, 134, 135, and 136 may include the first to third external electrodes 131, 132, and 133 disposed on portions of the fifth surface and the first and second surfaces 1 and 2, respectively, and fourth to sixth external electrodes 134, 135, and 136 disposed on portions of the sixth surface 6 and the first and second surfaces 1 and 2, respectively.

More specifically, the first external electrode 131 may be disposed on portions of the first, second, and fifth surfaces 1, 2, and 5 and further disposed on a portion of the third surface 3, and preferably may be disposed continuously on portions of the first, second, third, and fifth surfaces 1, 2, 3 and 5. The second external electrode 132 may be disposed on portions of the first, second, and fifth surfaces 1, 2, and 5. The third external electrode 133 may be disposed on portions of the first, second, and fifth surfaces 1, 2, and 5, and further on a portion of the fourth surface 4, and preferably may be disposed continuously on portions of the first, second, fourth, and fifth surfaces 1, 2, 4, and 5.

The fourth external electrode 134 may be disposed on portions of the first, second, and sixth surfaces 1, 2, and 6, and further on a portion of the third surface 3, and preferably may be disposed continuously on portions of the first, second, third, and sixth surfaces 1, 2, 3, and 6. The fifth external electrode 135 may be disposed on portions of the first, second, and sixth surfaces 1, 2, and 6. The sixth external electrode 136 may be disposed on portions of the first, second, and sixth surfaces 1, 2, and 6, and further on a portion of the fourth surface 4, and preferably may be disposed continuously on portions of the first, second, fourth, and sixth surfaces 1, 2, 4, and 6.

Here, the second-direction length of the second external electrode 132 in contact with the fifth surface 5 may satisfy 1.25 times or more and 2.75 times or less of the second-direction length of each of the first and third external electrodes 131 and 133 in contact with the fifth surface 5, and the second-direction length of the fifth external electrode 135 in contact with the sixth surface 6 may satisfy 1.25 times or more and 2.75 times or less of the second-direction length of each of the fourth and sixth external electrodes 134 and 136 in contact with the sixth surface 6.

Since the second-direction length of the second external electrode 132 in contact with the fifth surface 5 satisfies 1.25 times or more and 2.75 times or less of the second-direction length of each of the first and third external electrodes 131 and 133 in contact with the fifth surface 5 and the second-direction length of the fifth external electrode 135 in contact with the sixth surface 6 satisfies 1.25 times or more and 2.75 times or less of the second-direction length of each of the fourth and sixth external electrodes 134 and 136 in contact with the sixth surface 6, high-frequency characteristics (low ESL) and appropriate ESR may be realized.

The first to sixth external electrodes 131, 132, 133, 134, 135, and 136 may be disposed spaced apart from each other.

More specifically, based on the fifth surface 5, the first to third external electrodes 131, 132, and 133 may be disposed spaced apart in the second direction with the second external electrode 132 interposed therebetween, and based on the sixth surface 6, the fourth to sixth external electrodes 134, 135, and 136 may be disposed spaced apart in the second direction with the fifth external electrode 135 interposed therebetween.

Also, based on each of the first and second surfaces 1 and 2, the first and fourth external electrodes 131 and 134 may be disposed spaced apart from each other in the third direction, the second and fifth external electrodes 132 and 135 may be disposed spaced apart from each other in the third direction, and the third and sixth external electrodes 133 and 136 may be disposed spaced apart from each other in the third direction.

Here, when a width of a gap between two external electrodes adjacently disposed in the third direction among the first to sixth external electrodes 131, 132, 133, 134, 135, and 136 is D1 and a width of a gap between two external electrodes adjacently disposed in the second direction among the first to sixth external electrodes 131, 132, 133, 134, 135, and 136 is D2, 0<D2/D1≤1.2 may be satisfied.

Here, D1 may refer to a third-direction length in a direction, parallel to the third direction, and D2 may refer to a second-direction length in a direction, parallel to the second direction, but is not particularly limited thereto.

More specifically, for example, a width of a gap (e.g., the third-direction length) between the first external electrode 131 and the fourth external electrode 134 adjacently disposed in the third direction from the first external electrode 131 may be referred to as D1. In addition, a width of a gap (e.g., the second-direction length) between the fourth external electrode 134 and the fifth external electrode 135 adjacently disposed in the second direction from the fourth external electrode 134 may be referred to as D2. However, the present disclosure is not particularly limited thereto.

Since D1 and D2 satisfy 0<D2/D1≤1.2, high-frequency characteristics (low ESL) or appropriate equivalent series resistance (ESR) characteristics may be achieved. That is, the number of magnetic flux linkages per unit current in the high-frequency range may be minimized or a current loop current may be minimized, so that low ESL or appropriate ESR may be realized while capacitance is excellent.

A lower limit of D2/D1 is not particularly limited, but due to process limitations, D2/D1 may be 0.6 or more (0.6≤D2/D1), and in this case, D1 and D2 may satisfy 0.6≤D2/D1≤1.2.

Meanwhile, in the case of 1.2<D2/D1, it may be difficult to implement low ESL or implement appropriate ESR.

In addition, D1 may be 70 μm or more (70 μm≤D1), but this is only due to process limitations and the present disclosure is not particularly limited thereto. D1 and D2 may be obtained using an optical microscope or an electron microscope. Other methods and/or tools appreciated by one of ordinary skill in the art, even if not described in the present disclosure, may also be used.

The external electrodes 131, 132, 133, 134, 135, and 136 may be formed of any material having electrical conductivity, such as metal, and a specific material may be determined in consideration of electrical characteristics, structural stability, and the like, and the external electrodes 131, 132, 133, 134, 135, and 136 may further have a multilayer structure.

For example, the external electrodes 131, 132, 133, 134, 135, and 136 may include a first electrode layer disposed on the body 110 and a second electrode layer disposed on the first electrode layer. The external electrodes 131, 132, 133, 134, 135, and 136 may further include a third electrode layer disposed on the second electrode layer. Here, it may be preferable that the first to third electrode layers correspond to layers distinguished from each other. However, without being limited thereto, the first to fourth electrode layers may be distinguished according to the manufacturing process order, and at least some of the first to fourth electrode layers may not be distinguished from each other and may be observed as one layer.

In the present disclosure, “distinguished” may refer to that two layers are distinguished due to physical differences, chemical differences, and/or simple optical differences, and layers may be, but are not limited to, distinguished from each other by the presence or absence of an “interface.” The interface may refer to a surface by which two layers in contact with each other are distinguishable from each other, and may refer to, for example, a state in which two layers are distinguishable through differences in components, such as EDS analysis, using equipment, such as a scanning electron microscope (SEM).

That is, although not all are illustrated in the drawing, for convenience of description, the first to sixth external electrodes 131, 132, 133, 134, 135, and 136 may include first electrode layers 131a, 132a, 133a, 134a, 135a, and 136a disposed on the body 110, second electrode layers 131b, 132b, 133b, 134b, 135b, and 136b disposed on the first electrode layers 131a, 132a, 133a, 134a, 135a, and 136a, and further, third electrode layers 131c, 132c, 133c, 134c, 135c, and 136c disposed on the second electrode layers 131b, 132b, 133b, 134b, 135b, and 136b.

Here, the first electrode layers 131a, 132a, 133a, 134a, 135a, and 136a may be disposed on the first and second surfaces 1 and 2, and more preferably, may be disposed only on the first and second surfaces 1 and 2.

Since the first electrode layers 131a, 132a, 133a, 134a, 135a, and 136a are disposed only on the first and second surfaces 1 and 2, the second electrode layers 131b, 132b, 133b, 134b, 135b, and 136b may be disposed more uniformly and easily, and the shape of external electrodes that the present disclosure intends to form may be easily manufactured. Also, since the first electrode layers 131a, 132a, 133a, 134a, 135a, and 136a are not disposed on the third to sixth surfaces 3, 4, 5, and 6, the size of the external electrodes may be reduced, thereby reducing the size of the multilayer electronic component, which may be advantageous for mounting on or inside a substrate and the dielectric capacitance may be further improved.

Here, the first-direction average length of the first electrode layers 131a, 132a, 133a, 134a, 135a, and 136a may be 1 μm or more and 9 μm or less and the first electrode layers 131a, 132a, 133a, 134a, 135a, and 136a may have a uniform first-direction length within an error of +10% based on the first-direction average length.

Here, since the first-direction average length of the first electrode layers 131a, 132a, 133a, 134a, 135a, and 136a satisfies 1 μm or more and 9 μm or less, the dielectric capacitance and electrical characteristics may be excellent.

If the first-direction average length of the first electrode layers 131a, 132a, 133a, 134a, 135a, and 136a is less than 1 μm, it may be difficult to control the shape of the external electrodes 131, 132, 133, 134, 135, and 136 including the second electrode layers 131b, 132b, 133b, 134b, 135b, and 136b, and if the first-direction average length of the first electrode layers 131a, 132a, 133a, 134a, 135a, and 136a exceeds 9 μm, there may be a concern that the dielectric capacitance characteristics deteriorate compared to multilayer electronic components of the same size.

Here, the first-direction length or the first-direction average length of the first electrode layers 131a, 132a, 133a, 134a, 135a, and 136a may refer to the first-direction length or the first-direction average length of the respective first electrode layers 131a, 132a, 133a, 134a, 135a, and 136a of the first to sixth external electrodes 131, 132, 133, 134, 135, and 136.

The first-direction average length of the first electrode layers 131a, 132a, 133a, 134a, 135a, and 136a may be measured by scanning an image of the first- and third-direction cross-sections using a scanning electron microscope (SEM). More specifically, the first-direction average length of one first electrode layer may refer to an average value calculated by measuring the first-direction length at three points of one first electrode layer at equal gaps in the third direction in the scanned image, and the first-direction lengths measured at the three points may have an error within ±10% based on the first-direction average length. Other methods and/or tools appreciated by one of ordinary skill in the art, even if not described in the present disclosure, may also be used.

The first electrode layers 131a, 132a, 133a, 134a, 135a, and 136a may be formed by printing a first electrode layer paste including a first conductive metal on the body 110, the second electrode layers 131b, 132b, 133b, 134b, 135b, and 136b may be formed by forming a plating including a second conductive metal, and the third electrode layers 131c, 132c, 133c, 134c, 135c, and 136c may be formed by forming a plating including a third conductive metal.

However, the present disclosure is not particularly limited thereto, and the first to third electrode layers may be formed by a method of transferring an external electrode paste including a conductive metal or by a method of applying and then firing an external electrode conductive paste including a conductive metal.

The first conductive metal included in the first electrode layers 131a, 132a, 133a, 134a, 135a, and 136a may be a material having excellent electrical conductivity and may include, for example, at least one of nickel (Ni), copper (Cu), palladium (Pd), silver (Ag), gold (Au), platinum (Pt), tin (Sn), tungsten W, titanium (Ti), and alloys thereof, preferably nickel (Ni), and may more preferably include nickel (Ni) as a main component.

In addition, the “main component” in the present disclosure may refer to a component accounting for a relatively large weight ratio or atomic number ratio compared to other components and may refer to a component exceeding 50 wt % based on the weight of the entire material of a corresponding configuration, a component exceeding 50 at % based on the number of atoms, or a component exceeding 50 mol % based on the number of moles.

The second electrode layers 131b, 132b, 133b, 134b, 135b, and 136b may play a role of improving mounting characteristics.

The second conductive metal included in the second electrode layers 131b, 132b, 133b, 134b, 135b, and 136b may be a material having excellent electrical conductivity and may include, for example, at least one of nickel (Ni), copper (Cu), palladium (Pd), silver (Ag), gold (Au), platinum (Pt), tin (Sn), tungsten W, titanium (Ti), and alloys thereof, preferably copper (Cu), and may more preferably include copper (Cu) as a main component.

The third electrode layers 131c, 132c, 133c, 134c, 135c, and 136c may play a role of improving mounting characteristics.

The third conductive metal included in the third electrode layers 131c, 132c, 133c, 134c, 135c, and 136c may be a material having excellent electrical conductivity, and may include, for example, at least one of nickel (Ni), copper (Cu), palladium (Pd), silver (Ag), gold (Au), platinum (Pt), tin (Sn), tungsten W, titanium (Ti), and alloys thereof, may preferably include at least one of nickel (Ni), tin (Sn), copper (Cu), and alloys thereof, and may more preferably include at least one of nickel (Ni), tin (Sn), copper (Cu), and alloys thereof as a main component. However, without being limited thereto, the third electrode layers 131c, 132c, 133c, 134c, 135c, and 136c may include a plurality of layers including the third conductive metal.

Meanwhile, the size of the multilayer electronic component 100 is not particularly limited. The first-direction length (e.g., thickness) of the multilayer electronic component 100 may be referred to as T, the second-direction length (e.g., length) as L, and the third-direction length (e.g., width) as W. Here, the first-direction length may refer to the first-direction maximum length (e.g., thickness) of the multilayer electronic component, the second-direction length may refer to the second direction maximum length (e.g., length) of the multilayer electronic component, and the third-direction length may refer to the third direction maximum length (e.g., width) of the multilayer electronic component, which are not particularly limited thereto and may refer to generally used numerical values.

Here, T of the multilayer electronic component 100 may satisfy 30 μm≤T≤⅗×W, W may satisfy W≤750 μm, and W and L may satisfy 1.75≤L/W≤2.25. T, L, and W may be obtained using an optical microscope or an electron microscope. Other methods and/or tools appreciated by one of ordinary skill in the art, even if not described in the present disclosure, may also be used.

Since T, L, and W of the multilayer electronic component 100 satisfy the above conditions, noise of a high-speed integrated circuit (IC) may be reduced and the multilayer electronic component 100 may be suitable for a land side capacitor (LSC).

Hereinafter, the present disclosure will be described in more detail through experimental examples, but this is to help a specific understanding of the disclosure and the scope of the present disclosure is not limited by the preferred experimental examples.

### Experimental Example

Table 1 below illustrates the ESL and ESR characteristics measured according to the ratio (D2/D1) of the gap (D2, length) between two external electrodes adjacently disposed in the second direction to the gap (D1, width) between two external electrodes adjacently disposed in the third direction.

In Table 1, the width (W) and length (L) were measured as the width (W) and length (L) of the multilayer electronic component, and the unit is micrometer (μm).

An external electrode first length was measured as a length of the fourth external electrode in contact with the sixth surface, and the unit is micrometer (μm). The external electrode second length was measured as a length of the fifth external electrode in contact with the sixth surface, and the unit is micrometer (μm).

The external electrode length gap D2 was measured as a second-direction gap between the fourth external electrode and the fifth external electrode based on the second surface, and the unit is micrometer (μm). The external electrode width gap D1 was measured as a third-direction gap between the first external electrode and the fourth external electrode based on the second surface, and the unit is micrometer (μm).

The ESL measurement was performed according to the EIA-970 standard, and as for the measurement method, the impedance (pH) was measured when a voltage of 1 GHz frequency was applied to the sample chip (MLCC) using a network analyzer, and described in Table 1 below.

The ESR measurement was performed according to the EIA-970 standard, and as for the measurement method, the resistance (mΩ) when the self-resonant frequency (SRF) condition was applied using a network analyzer, and described in Table 1 below.

Experimental Examples 1 to 6 were manufactured as multilayer electronic components including a body including a first internal electrode layer including a first lead portion and a second internal electrode layer including a second lead portion and first to sixth external electrodes disposed on the body.

TABLE 1

| | | | First | Second | External | | | | |
|---|---|---|---|---|---|---|---|---|---|
| | | | length of | length of | electrode | External | | | |
| | Width | Length | external | external | length gap | electrode | | ESL@1 | ESR@ |
| | (W) | (L) | electrode | electrode | (D2) | width gap | | GHz | SRF |
| Sample | (μm) | (μm) | (μm) | (μm) | (μm) | (D1) (μm) | D2/D1 | (pH) | (mΩ) |
| Experi- | 750 | 1500 | 340 | 680 | 70 | 70 | 1 | 17.9 | 29.9 |
| mental | | | | | | | | | |
| Example | | | | | | | | | |
| 1 | | | | | | | | | |
| Experi- | 750 | 1500 | 220 | 688 | 186 | 310 | 0.6 | 25.9 | 29.8 |
| mental | | | | | | | | | |
| Example | | | | | | | | | |
| 2 | | | | | | | | | |
| Experi- | 750 | 1500 | 220 | 564 | 248 | 310 | 0.8 | 27.0 | 29.9 |
| mental | | | | | | | | | |
| Example | | | | | | | | | |
| 3 | | | | | | | | | |
| Experi- | 750 | 1500 | 220 | 440 | 310 | 310 | 1 | 28.2 | 29.9 |
| mental | | | | | | | | | |
| Example | | | | | | | | | |
| 4 | | | | | | | | | |
| Experi- | 750 | 1500 | 220 | 316 | 372 | 310 | 1.2 | 29.2 | 29.9 |
| mental | | | | | | | | | |
| Example | | | | | | | | | |
| 5 | | | | | | | | | |
| Experi- | 750 | 1500 | 220 | 192 | 434 | 310 | 1.4 | 30.8 | 30.1 |
| mental | | | | | | | | | |
| Example | | | | | | | | | |
| 6 | | | | | | | | | |

For Experimental Examples 1 to 5 in which D2/D1 satisfies 1.2 or less, both ESL and ESR have values of 30.0 pH and 30 mΩ or less, and in particular, ESR has a maximum value of 29.9 mΩ. Meanwhile, for Experimental Example 6 in which D2/D1 corresponds to 1.4, both ESL and ESR have values exceeding 30.0 pH and 30 mΩ, and in particular, ESR has a value of 30.1 mΩ.

Therefore, it can be seen that, when D2/D1 is 1.2 or less high-frequency characteristics (low ESL) and an appropriate ESR value are obtained.

Table 2 below illustrates measured capacitance characteristics according to average thicknesses of the first electrode layer.

Experimental Examples 7 to 13 were manufactured as multilayer electronic components including a body including a first internal electrode layer including a first lead portion and a second internal electrode layer including a second lead portion and first to sixth external electrodes disposed on the body.

The first to sixth external electrodes of Experimental Example 7 do not include a first electrode layer and include only a second electrode layer including copper (Cu) as a main component and disposed on the body.

The first to sixth external electrodes of Experimental Examples 8 to 13 include a first electrode layer including nickel (Ni) as a main component and disposed only on the first and second surfaces of the body and a second electrode layer including copper (Cu) as a main component and disposed on the first electrode layer.

The average thickness of the first electrode layer is measured and described by measuring the average thickness of the first electrode layer of each of the fourth external electrodes disposed on the first and second surfaces, and the unit is micrometer (μm).

Thickness (T) is described as the thickness of the multilayer electronic component including the fourth external electrodes disposed on the first and second surfaces, and the unit is micrometer (μm).

The external electrode thickness is described by measuring the thickness of each of the fourth external electrodes disposed on the first and second surfaces and adding them together to measure the total thickness, and is described in micrometers (μm).

The width (W) and length (L) are described by measuring the width (W) and length (L) of the multilayer electronic component.

A dielectric layer average thickness is described by measuring an average thickness of the dielectric layer disposed between the first internal electrode layer and the second internal electrode layer, and is described in micrometers (μm).

The dielectric capacitance (%) is relative capacitance measured based on the dielectric capacitance of Experimental Example 7 (100%), and is described as a 5 percentage (%).

TABLE 2

| | Average | | | | | | | |
|---|---|---|---|---|---|---|---|---|
| | thickness | | Thickness | | | | Average | |
| | of first | | of | | | | thickness of | |
| | electrode | | external | Thickness | Width | Length | dielectric | Dielectric |
| | layer | Thickness | electrode | of body | (W) | (L) | layer | capacitance |
| Sample | (μm) | (T) (μm) | (μm) | (μm) | (μm) | (μm) | (μm) | (%) |
| Experi- | 0 | 89 | 20 | 69 | 750 | 750 | 1.57 | 100% |
| mental | | | | | | | | |
| Example | | | | | | | | |
| 7 | | | | | | | | |
| Experi- | 1 | 89 | 22 | 67 | 750 | 1,313 | 1.57 | 188% |
| mental | | | | | | | | |
| Example | | | | | | | | |
| 8 | | | | | | | | |
| Experi- | 3 | 89 | 26 | 63 | 750 | 1,313 | 1.57 | 167% |
| mental | | | | | | | | |
| Example | | | | | | | | |
| 9 | | | | | | | | |
| Experi- | 5 | 89 | 30 | 59 | 750 | 1,313 | 1.57 | 153% |
| mental | | | | | | | | |
| Example | | | | | | | | |
| 10 | | | | | | | | |
| Experi- | 7 | 89 | 34 | 55 | 750 | 1,313 | 1.57 | 132% |
| mental | | | | | | | | |
| Example | | | | | | | | |
| 11 | | | | | | | | |
| Experi- | 9 | 89 | 38 | 51 | 750 | 1,313 | 1.57 | 118% |
| mental | | | | | | | | |
| Example | | | | | | | | |
| 12 | | | | | | | | |
| Experi- | 11 | 89 | 42 | 47 | 750 | 1,313 | 1.57 | 97% |
| mental | | | | | | | | |
| Example | | | | | | | | |
| 13 | | | | | | | | |

In the case of Experimental Example 7 not including the first electrode layer, the first to sixth external electrodes including the second electrode layer were formed, but at least one of the first to sixth external electrodes had an error exceeding ±10% based on the average thickness of the external electrode, so that the external electrode of uniform thickness was not formed.

In the case of Experimental Examples 8 to 12 in which the average thickness of the first electrode layer was 1 μm or more and 9 μm or less and the error was within ±10% based on the average thickness of the external electrode, it can be seen that the dielectric capacitance was improved compared to Experimental Example 7.

In the case of Experimental Example 13 in which the error was within ±10% based on the average thickness of the external electrode but the average thickness of the first electrode layer was 11 μm, it can be seen that the dielectric capacitance was reduced compared to Experimental Example 7.

Therefore, when the average thickness of the first electrode layer was 1 μm or more and 9 μm or less, it can be seen that an external electrode of uniform thickness was formed while the dielectric properties were improved.

Next, FIG. 5 schematically illustrates Lm measured according to the results of evaluating moisture resistance reliability of samples of Comparative Example and Example.

Here, Lm is a measured gap between the main portion of the internal electrode layer and one of the second-direction surfaces.

In an evaluation of moisture resistance reliability, a case in which a short occurred when a voltage of 5 Vr was applied for 100 hours under a temperature condition of 85° C. and a humidity condition of 85% was evaluated as defective, and a case in which a short did not occur was evaluated as normal.

More specifically, Comparative Example is a graph of measured Lm of normal samples that did not have a defect in the moisture resistance reliability evaluation when the ratio (D2/D1) of the gap D2 between two external electrodes adjacently disposed in the second direction to the gap D1 between two external electrodes adjacently disposed in the third direction exceeds 1.2 (1.2<D2/D1).

Also, Example is a graph of measured Lm of normal samples that did not have a defect in the moisture resistance reliability evaluation when the ratio (D2/D1) of the gap D2 between two external electrodes adjacently disposed in the second direction to the gap D1 between two external electrodes adjacently disposed in the third direction is 1.2 or less (D2/D1≤1.2).

As can be seen in the graphs, in the case of Comparative Example, there were only cases in which Lm exceeded 15 μm in the samples that were evaluated as normal in the moisture reliability evaluation, but in the case of Example, there were cases in which Lm was 3 μm or more and 15 μm or less in the samples that were evaluated as normal in the moisture reliability evaluation.

From this, it can be seen that the moisture reliability is excellent when D2/D1 is 1.2 or less (D2/D1≤1.2), and it can be seen that excellent moisture reliability may be secured when the Lm value is 3 μm or more.

One of the various effects of the present disclosure is to provide a multilayer electronic component with excellent high-frequency characteristics (low ESL).

One of the various effects of the present disclosure is to provide the multilayer electronic component implementing intended equivalent series resistance (low ESR).

One of the various effects of the present disclosure is to provide the thin multilayer electronic component.

One of the various effects of the present disclosure is to provide the multilayer electronic component with excellent capacitance characteristics.

However, the various advantageous advantages and effects of the present disclosure are not limited to the aforementioned contents and will be more easily understood in the process of describing specific embodiments of the present disclosure.

Although the embodiments or examples of the present disclosure have been described in detail above, the present disclosure is not limited to the embodiments described above and the accompanying drawings, but is intended to be limited by the appended claims. Accordingly, various forms of substitution, modification, and change may be made by those skilled in the art within the scope without departing from the technical idea of the present disclosure described in the claims, and this will also be considered to fall within the scope of the present disclosure.

The expression “an exemplary embodiment or one example” used in the present disclosure does not refer to identical examples and is provided to stress different unique features between each of the examples. However, examples provided in the following description are not excluded from being associated with features of other examples and implemented thereafter. For example, even if matters described in a specific example are not described in a different example thereto, the matters may be understood as being related to the other example, unless otherwise mentioned in descriptions thereof.

The terms used herein are for the purpose of describing particular embodiments only and are not intended to limit the example embodiments. As used herein, the singular forms “a,” “an” and “the” are intended to include the plural forms as well, unless the context clearly indicates otherwise.

What is claimed is:

1. A multilayer electronic component comprising:
a body including a dielectric layer and internal electrode layers alternately disposed with the dielectric layer in a first direction, the body including first and second surfaces opposing each other in the first direction, third and fourth surfaces opposing each other in a second direction and connected to the first and second surfaces, and fifth and sixth surfaces opposing each other in a third direction and connected to the first to fourth surfaces; and
an external electrode including a first electrode layer disposed on the body, and a second electrode layer disposed on the first electrode layer and connected to the internal electrode layers,
wherein the external electrode includes first to third external electrodes disposed on portions of the first, second, and fifth surfaces, respectively, and fourth to sixth external electrodes disposed on portions of the first, second, and sixth surfaces, respectively, and
0<D2/D1≤1.2 in which D1 is a width of a gap between two adjacent external electrodes, among the first to sixth external electrodes, in the third direction and D2 is a width of a gap between two adjacent external electrodes, among the first to sixth external electrodes, in the second direction.

2. The multilayer electronic component of claim 1, wherein D1 and D2 satisfy 0.6≤D2/D1≤1.2.

3. The multilayer electronic component of claim 1, wherein
the first to third external electrodes are disposed spaced apart from each other in the second direction with the second external electrode interposing the first and third external electrodes, the fourth to sixth external electrodes are disposed spaced apart from each other in the second direction with the fifth external electrode interposing the fourth and sixth external electrodes,
the internal electrode layers include first and second internal electrode layers, and
the first internal electrode layer includes a first main portion and 1-1 to 1-3 lead portions connected to the first main portion, the 1-1 to 1-3 lead portions are disposed spaced apart from each other, and connect to the first external electrode, the third external electrode, and the fifth external electrode, respectively.

4. The multilayer electronic component of claim 3, wherein the second internal electrode layer includes a second main portion and 2-1 to 2-3 lead portions connected to the second main portion, the 2-1 to 2-3 lead portions are disposed spaced apart from each other, and connect to the fourth external electrode, the sixth external electrode, and the second external electrode, respectively.

5. The multilayer electronic component of claim 3, wherein the second internal electrode layer includes a second main portion and 2-1 to 2-3 floating portions spaced apart from the second main portion, the 2-1 to 2-3 floating portions are disposed spaced apart from each other, and connect to the fourth external electrode, the sixth external electrode, and the second external electrode, respectively.

6. The multilayer electronic component of claim 4, wherein the first and second main portions are disposed spaced apart from at least one surface selected from the third to sixth surfaces by Lm, and Lm satisfies 3 μm≤Lm.

7. The multilayer electronic component of claim 6, wherein Lm satisfies 3 μm≤Lm≤30 μm.

8. The multilayer electronic component of claim 5, wherein the first and second main portions are disposed spaced apart from at least one surface selected from the third to sixth surfaces by Lm, and Lm satisfies 3 μm≤Lm.

9. The multilayer electronic component of claim 8, wherein Lm satisfies 3 μm≤Lm≤30 μm.

10. The multilayer electronic component of claim 1, wherein, in the second direction:
a length of the second external electrode in contact with the fifth surface satisfies 1.25 times or more and 2.75 times or less of a length of each of the first and third external electrodes in contact with the fifth surface, and
a length of the fifth external electrode in contact with the sixth surface satisfies 1.25 times or more and 2.75 times or less of a length of each of the fourth and sixth external electrodes in contact with the sixth surface.

11. The multilayer electronic component of claim 1, wherein the first electrode layer is disposed on the first and second surfaces.

12. The multilayer electronic component of claim 1, wherein, in the first direction, an average length of the first electrode layer is 1 μm or more and 9 μm or less.

13. The multilayer electronic component of claim 1, wherein the external electrode further includes a third electrode layer disposed on the second electrode layer.

14. The multilayer electronic component of claim 1, wherein the multilayer electronic component satisfies 30 μm≤T≤3/5×W, in which Tis a length of the multilayer electronic component in the first direction, and W is a length of the multilayer electronic component in the third direction.

15. The multilayer electronic component of claim 1, wherein, in the second direction, a length of the second external electrode in contact with the fifth surface is longer than a length of each of the first and third external electrodes in contact with the fifth surface.

16. The multilayer electronic component of claim 1, wherein, in the second direction, a length of the fifth external electrode in contact with the sixth surface is longer than a length of each of the fourth and sixth external electrodes in contact with the sixth surface.

17. A multilayer electronic component comprising:
a body including a dielectric layer and internal electrode layers alternately disposed with the dielectric layer in a first direction, the body including first and second surfaces opposing each other in the first direction, third and fourth surfaces opposing each other in a second direction and connected to the first and second surfaces, and fifth and sixth surfaces opposing each other in a third direction and connected to the first to fourth surfaces; and
a plurality of external electrodes including a first electrode layer disposed on the body, and a second electrode layer disposed on the first electrode layer and connected to the internal electrode layers,
wherein 0<D2/D1≤1.2 in which D1 is a width of a gap between two adjacent external electrodes, among the plurality of external electrodes, in the third direction and D2 is a width of a gap between two adjacent external electrodes, among the plurality of external electrodes, disposed in the second direction.

18. The multilayer electronic component of claim 17, wherein the plurality of external electrodes include a first external electrode disposed on a corner of the body, and a second external electrode spaced apart from the first external electrode, and
in the second direction, a length of the second external electrode in contact with a surface of the body is longer than a length of the first external electrode in contact with the surface of the body.
